(19) United States
(12) Patent Application Publication
(10) Pub. No.: US 2012/0067979 A1
(43) Pub. Date: Mar. 22, 2012

(54) MICROBUBBLE-GENERATING SHOWER

(75) Inventor: Hyun Woo Kim, Incheon (KR)

(73) Assignee: MEC, Incheon (KR)

(21) Appl. No.: 13/375,253

(22) PCT Filed: May 3, 2010
(86) PCT No.: PCT/KR10/02811

§ 371 Date: Nov. 30, 2011

(30) Foreign Application Priority Data
Jun. 2, 2009 (KR) 10-2009-0048725

(51) Int. Cl. B05B 7/06

(52) U.S. Cl. 239/427

(57) ABSTRACT

A micro-bubble generating shower includes a shower body, which has defined therein a passage, through which tap water flows. A shower head is integrally provided in the upper portion of the shower body, and has a receptacle, which is connected to the passage. A bubble nozzle is coupled to the shower head, and generates micro-bubbles by converting dissolved oxygen contained in the tap water into ultra-micro-bubbles having a size on the micrometer scale. A discharge nozzle discharges the tap water that contains the micro-bubbles, which are generated by the bubble nozzle, under a predetermined pressure. The shower enhances the effects of purifying and sterilizing the tap water using the micro-bubbles, thereby eliminating skin bacilli.

### TECHNICAL FIELD

The present invention relates to a micro-bubble shower, and more particularly, to a micro-bubble shower provided with a bubble nozzle, which generates micro-bubbles by converting dissolved oxygen contained in tap water into ultra-micro-bubbles having a size on the micrometer scale using the pressure of the tap water, in order to enhance the effects of purifying and sterilizing the tap water using the micro-bubbles, thereby eliminating skin bacilli, and generates anions.

### BACKGROUND ART

In general, a shower is a device that has defined therein a water passage, and has a plurality of perforated discharge holes, which communicate with the water passage. The base of the shower is connected to a water supply line, which supplies water. A user can shower intended parts of his/her body by grasping the shower.

However, the shower of the related art has problems in that harmful bacilli breed in the water passage inside the shower when a long time has passed since the installation of the shower. When the user showers, bacilli may be carried in water, such that they come into direct contact with the skin, thereby causing harm to the skin.

In particular, there are problems in that, in severe cases, the harmful bacilli may cause skin diseases, such as itching, allergies, or atopy, to persons whose skin is sensitive.

FIG. 1 and FIG. 2 are views showing a shower having a sterilizing function of the related art.

As shown in the figure, a shower 100 of the related art is disclosed in Korean Utility Model Registration No. 0139864. In the shower 100, a shower head 110 has a discharge net 112, through which shower water is discharged, and a shower handle 120 has defined therein a duct 102, which communicates with the shower head 110. Filter casings 130 are disposed inside the duct 102 of the shower handle 120 such that they cross the passage of shower water, and each of the filter casings has water passage holes 132 defined in the upper and lower sections thereof. An inlet-side filter means 160 includes an ultrafine copper fiber coil 140, which is stored in the central portion of the filter casing 130, and carbon fiber nets 150, which are respectively disposed on and under the copper fiber coil 140. A discharge-size filter means 170 is disposed in the rear of the discharge net 112 inside the shower head 110 such that it crosses the passage of the shower water. The discharge-size filter means 170 includes an ultrafine copper fiber bundle 140, which is stored in the central portion of the filter casing 130 having the water passage holes 132 in the upper and lower sections thereof, and carbon fiber nets 150, which are respectively disposed on and under the copper fiber coil 140.

The shower 100 of the related art having the above-described configuration is intended to prevent the breeding of bacilli and maintain an excellent water sterilizing effect due to the disposition of the inlet-side filter means 150 and the discharge-side filter means 160, such as a sterilization filter, inside the shower 100. However, even though such sterilization filters are added, there is a problem in that the filters must be replaced periodically since the sterilization filters do not have a long lifetime. There is also a problem in that cost, such as the cost required for the replacement of the sterilization filters, is expensive.

In addition, a shower of the related art shown in FIG. 2 is disclosed in Korean Utility Model Registration No. 0336396. The shower 200 includes a shower 230, which has defined a water passage 210 therein. Silver foam 220 is disposed inside the water passage 210, the silver foam 220 being formed by manufacturing silver into a block-like foam such that a number of pores 222 are formed inside the block, so that water flowing through the water passage 210 is sterilized by the silver foam 220. Discharge holes 240 are formed in the shower such that they communicate with the water passage 210. The base of the shower 230 is connected to a water supply line, which supplies water.

The shower 200 of the related art having the above-described configuration was invented to use silver as a main component in order to further increase the lifetime of the silver foam 220, which acts as a sterilization filter, thereby simplifying its use and reducing installation cost. However, this device merely increases the lifetime of the shower like that of the related art shown in FIG. 1. Whenever water flows through the silver foam, a variety of impurities are collected inside the silver foam 220, which then loses its sterilization effect, and contrary to its purpose, allows bacilli to breed. Therefore, the silver foam 220 must also be replaced after a predetermined amount of time has passed.

In addition, since the silver foam 220, which acts as a sterilization filter, contains silver as its main component, the silver foam 220 is necessarily more expensive than other common sterilization filters. Thus, replacement cost is also increased, thereby aggravating the problem of poor economy.

### DISCLOSURE

### Technical Problem

Accordingly, the present invention has been made keeping in mind the above problems occurring in the related art, and is intended to provide a bubble nozzle, which generates micro-bubbles by converting dissolved oxygen contained in tap water into ultra-micro-bubbles having a size on the micrometer scale, and a micro-bubble shower, which has a discharge nozzle for discharging the tap water in which the micro-bubbles are contained.

The present invention is also intended to maximize the effects of purifying and sterilizing the tap water using the bubble nozzle, which generates ultra-micro-bubbles having a size on the micrometer scale by expanding dissolved oxygen contained in the tap water using a vortex caused by frictional resistance and pressure resistance due to variations in the pressure of the tap water, and thus to prevent various kinds of skin diseases, such as itching, allergies, atopy and the like, caused by harmful bacilli contained in the tap water.

### Technical Solution

In order to realize the foregoing objects, an aspect of the present invention provides a micro-bubble generating shower, which includes a shower head integrally provided in an upper portion of a shower body, which defines therein a passage through which tap water flows. The shower head includes a receptacle extending through the shower head and connected to the passage and a coupling section formed in a front end of the receptacle and having threads. A bubble nozzle is fixedly fitted into the receptacle of the shower head, and includes a fastening hole extending through a central portion thereof, inlets connected to the passage such that the tap water is introduced into the inlets, pressure resisting portions for generating frictional resistance to dissolved oxygen contained in the tap water that is introduced into the inlets, friction inducing portions connected to the pressure resisting portions such that the frictional resistance occurs in the dissolved oxygen in the tap water, and outlets formed in lower ends of the friction inducing portions, such that the tap water exits through the outlets. Pressure resistance of the pressure resisting portions and the frictional resistance of the friction inducing portions convert the dissolved oxygen in the tap water into ultra-micro-bubbles in a micrometer scale so that micro-bubbles are created, so that effects of purifying and sterilizing the tap water are maximized. A discharge nozzle is coupled to the coupling section of the shower head, with a watertight packing being compressed between the discharge nozzle and the coupling section. The discharge nozzle includes a screw hole fastened with the fastening hole of the bubble nozzle using a screw, such that the discharge nozzle is fixed to the bubble nozzle, a fastening cover surrounding an outer surface of the screw, and a plurality of discharge holes through which the tap water that contains the micro-bubbles generated by the bubble nozzle is discharged. The discharge holes of the discharge nozzle include a plurality of first discharge holes formed in a central portion of the discharge nozzle and a plurality of second discharge holes spaced apart at predetermined intervals from the first discharge nozzles. An inner wall is formed inside a portion of the bubble nozzle in which the first discharge holes are formed, such that the inner wall causes the tap water that contains the micro-bubbles and exits from the bubble nozzle to flow backward, thereby generating secondary micro-bubbles.

Another aspect of the present invention provides a micro-bubble generating shower, in which the inlets have a diameter ranging from 0.7 mm to 1.2 mm, and ten inlets are formed in the bubble nozzle.

### Advantageous Effects

According to the present invention as set forth above, the effects of purifying and sterilizing the tap water are maximized using the bubble nozzle, which generates micro-bubbles by expanding dissolved oxygen contained in the tap water into ultra-micro-bubbles having a size on the micrometer scale using a vortex caused by frictional resistance and pressure resistance due to variations in the pressure of the tap water. Accordingly, various kinds of skin diseases, such as itching, allergies, atopy and the like, caused by harmful bacilli contained in the tap water can be prevented.

Furthermore, according to the present invention, since the bubble nozzle, which generates micro-bubbles by converting dissolved oxygen contained in tap water into ultra-micro-bubbles at a size on the micrometer scale, is provided, the bubble nozzle can be used semi-permanently, and costs related to replacement and installation can be significantly reduced.

### DESCRIPTION OF DRAWINGS

FIG. 1 is a view showing a shower having a sterilizing filter of the related art;

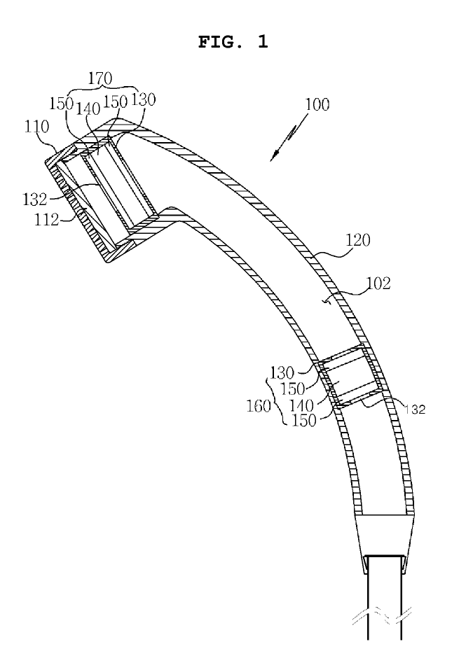

FIG. 2 is a view showing a shower having a sterilizing function of the related art;

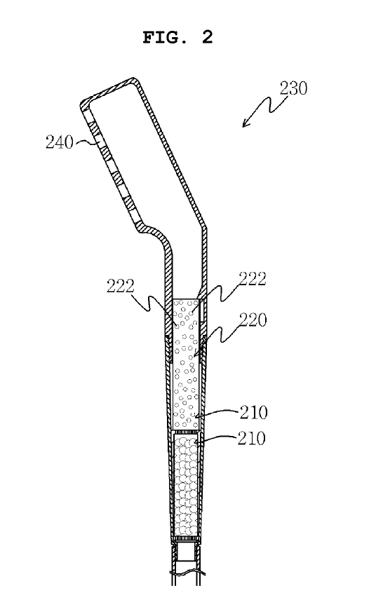

FIG. 3 is an exploded perspective view showing a micro-bubble shower according to an exemplary embodiment of the present invention;

FIG. 4 is an assembled cross-sectional view showing the micro-bubble shower according to an exemplary embodiment of the present invention;

FIG. 5 is a view showing the bubble nozzle of the micro-bubble shower according to an exemplary embodiment of the present invention;

FIG. 6 is a view showing the discharge nozzle of the micro-bubble shower according to an exemplary embodiment of the present invention; and

FIG. 7 to FIG. 9 are views showing the operation states of the micro-bubble shower according to an exemplary embodiment of the present invention.

<Major Reference Numerals of the Drawings>

| | |
|---|---|
| 300: micro-bubble shower | 310: shower body |
| 312: passage | 314: water supply line |
| 320: shower head | 322: receptacle |
| 324: coupling section | 326: inclined guide |
| 328: threads | 330: bubble nozzle |
| 331: inner wall | 332: inlet |
| 334: fastening hole | |
| 335: pressure resisting portion | |
| 336: micro-bubble generator | |
| 337: friction inducing portion | |
| 338: outlet | 340: discharge nozzle |
| 342: screw hole | 344: fastening cover |
| 345: inner wall | 346: first discharge hole |
| 348: second discharge hole | 350: watertight packing |

### MODE FOR INVENTION

Reference will now be made in detail to various embodiments of the present invention, examples of which are illustrated in the accompanying drawings and described below. Throughout this document, reference should be made to the drawings, in which the same reference numerals and signs are used throughout the different drawings to designate the same or similar components. In the following description of the present invention, detailed descriptions of known functions and components incorporated herein will be omitted when they may make the subject matter of the present invention unclear.

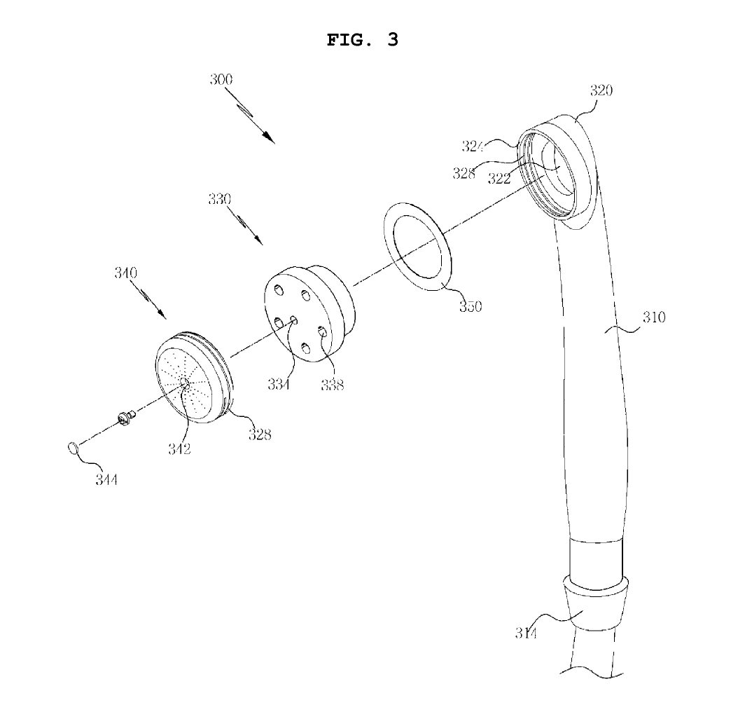

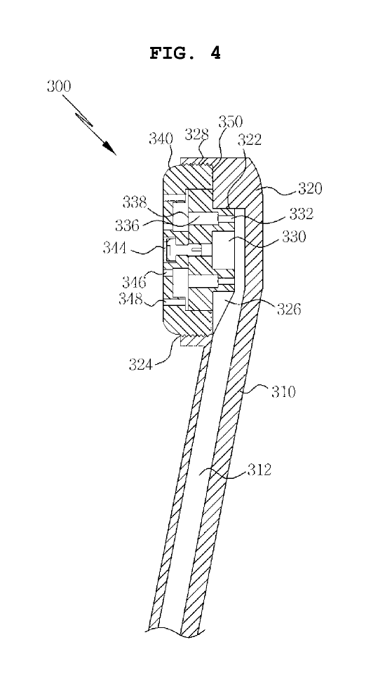

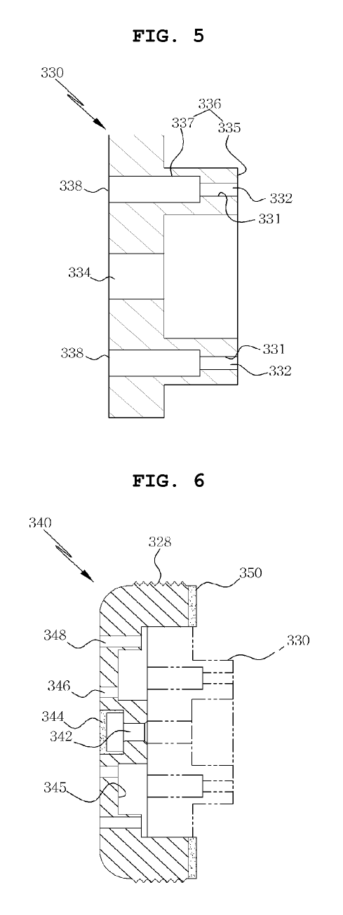

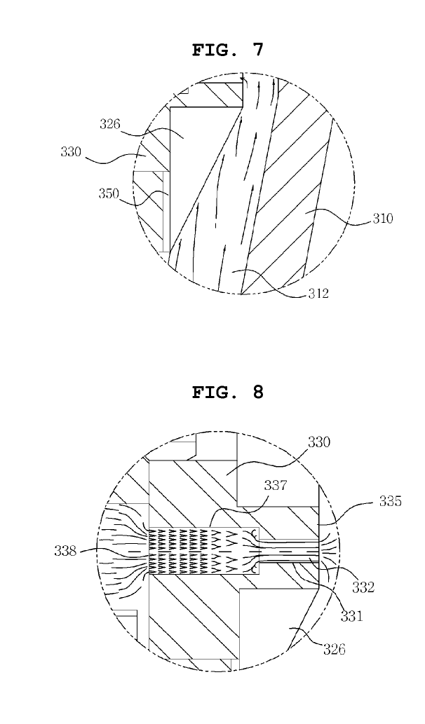

FIG. 3 is an exploded perspective view showing a micro-bubble shower according to an exemplary embodiment of the present invention, FIG. 4 is an assembled cross-sectional view showing the micro-bubble shower according to an exemplary embodiment of the present invention, FIG. 5 is a view showing the bubble nozzle of the micro-bubble shower according to an exemplary embodiment of the present invention, and FIG. 6 is a view showing the discharge nozzle of the micro-bubble shower according to an exemplary embodiment of the present invention.

As shown in the figures, the micro-bubble shower 300 of the present invention includes a shower body 310, which has defined therein a passage 312, through which tap water or the like flows. A shower head 320 is integrally provided in the upper portion of the shower body 310, and has a receptacle 322, which is connected to the passage 312. A bubble nozzle 330 is coupled to the shower head 320, and generates micro-bubbles by converting dissolved oxygen contained in the tap water into ultra-micro-bubbles having a size on the micrometer scale. A discharge nozzle 340 discharges the tap water that contains the micro-bubbles, which are generated by the bubble nozzle 330, under a predetermined pressure.

The shower body 310 has a variety of shapes so that a user can hold its outer circumference in order to take a shower. The hollow passage 312 extends from the lower portion to the upper portion through the inside of the shower body 310, so that the tap water flows through it. The lower end of the shower body 310 is connected to a water supply line 314, which supplies the tap water through the passage 312. The shower head 320 is integrally provided in the upper portion of the shower body 310.

The shower head 320 is provided in the upper portion of the shower body 310, such that the shower body 310 extends through the shower head 310, so that the tap water flowing through the passage 312 can be discharged through it. In the shower head 320, the receptacle 322 is connected to the passage 312, such that the bubble nozzle 330 is stably and fixedly fitted into it. In the front end of the receptacle 322, i.e. the inner circumference of one front end of the shower head 320, a coupling section 324 is provided coaxially with the receptacle 322, such that the discharge nozzle 340 is coupled thereto.

In the lower portion of the shower head 320, i.e. the lower portion of the receptacle 322, an inclined guide 326, which increases the pressure of the tap water flowing through the passage 312 of the shower body 310, is formed. The inclined guide 326 is formed at an incline having a predetermined angle such that the diameter of the passage 312 gradually decreases, so that the pressure of the tap water that flows through the passage 312 of the shower body 310 increases while the tap water passes through the inclined guide 326.

That is, the diameter of the passage 312 that is formed in the lower end of the receptacle 322 of the shower head 320 is smaller than that of the passage 312 that is formed in the upper end of the shower body 310, but the diameter of the passage 312 gradually decreases through the inclined guide 326. This configuration increases the pressure of the tap water that flows through the passage 312 of the shower body 320, so that the generation of micro-bubbles in the bubble nozzle 330 and the discharge nozzle 340, which will be described later, is promoted. As a result, the conversion of dissolved oxygen in the tap water into bubbles is further activated, thereby maximizing the effects of purifying and sterilizing the tap water.

Furthermore, the coupling section 324 of the shower head 320 has threads 328 defined in the inner circumference thereof, to which the discharge nozzle 340, which will be described later, is coupled, in order to enhance the water-tightness of the micro-bubble shower. Threads 328, which correspond to the threads 328, are preferably formed in the outer circumference of the discharge nozzle 340, such that the threads 328 can be screw-engaged with each other. However, the present invention is not limited thereto.

Although not shown in the figures, a plurality of protrusion recesses (not shown) may be formed in the inner circumference of the coupling section 324, and fixing protrusions (not shown), which are fixedly fitted into the protrusion recesses, may be formed in the outer circumference of the discharge nozzle 340. This allows the discharge nozzle 340 to be interference-fitted into the coupling section 324 of the shower head 320.

In addition, a watertight packing 350 is provided between the shower head 320 and the discharge nozzle 340. The watertight packing 350 is made of a rubber material having a predetermined level of elasticity in order to increase the water-tightness of the micro-bubble shower 300. When the discharge nozzle 340 is coupled to the coupling section 324 of the shower head 320, the watertight packing 350 is compressed to preferably close any minute gap, which would otherwise be formed between the discharge nozzle 340 and the shower head 320, thereby enhancing the water-tightness of the micro-bubble shower 300.

The bubble nozzle 330 generates micro-bubbles by converting dissolved oxygen contained in the tap water that flows through the passage 312 into ultra-micro-bubbles having a size on the micrometer scale, so that the tap water is purified and sterilized by the micro-bubbles. The bubble nozzle 330 is fixedly fitted into the receptacle 322 of the shower head 320, and has a fastening hole 334 in the central portion thereof, the fastening hole 334 being fastened with the discharge nozzle 340, which will be described later.

As shown in FIG. 5, the bubble nozzle 330 has inlets 332 into which the tap water from the passage 312 of the head 320 is introduced. A micro-bubble generator 336 is formed in one end of the inlets 332, and includes pressure resisting portions 335 and friction inducing portions 337. Outlets 338 are formed in one end of the micro-bubble generator 336.

The inlets 332 are configured so that the tap water containing dissolved oxygen is introduced in the state in which the tap water has a predetermined pressure which is given while the tap water flows through the inclined guide 326 of the shower head 320. The micro-bubble shower 300 may preferably have one or multiple inlets depending on the flow rate as required, but ten or more inlets 332 may preferably be formed in the present invention.

In addition, it is preferred that the diameter of the inlets 332 range from 0.7 mm to 1.2 mm so that water that is introduced through the inlets 332 can have a very fast flow rate. In the present invention, however, it is preferred that the diameter be 1.0 mm.

The micro-bubble generator 336 serves to generate micro-bubbles by converting dissolved oxygen contained in tap water into ultra-micro-bubbles having a size on the micrometer scale using the pressure resistance of the pressure resisting portions 335 and the frictional resistance of the friction inducing portions 337. In the micro-bubble generator 336, each pressure resisting portion 335 perpendicularly extends from an inner wall 331, which is formed on one end of a corresponding inlet 332, to cause pressure resistance to the tap water that is introduced from the inlet 332. Each friction inducing portion 337 is connected to a corresponding pressure resisting portion 335 so that frictional resistance occurs in the tap water that flows through a corresponding inlet 332 and the pressure resisting portion 335, and has the same center as the inlet 332.

In addition, the outlets 338 through which the tap water flows out are formed at the front end of the micro-bubble generator 336, i.e. the front end of the friction inducing portions 337. The outlets 338 are formed such that the diameter of the outlets 338 is greater than the diameter of the inlets 332, with the ratio of the diameter of the inlet 332 to the diameter of the outlet 338 being 1:2.4 or more. In addition, the micro-bubble generator 336 is elongated such that the ratio of the diameter of the outlet 338 to the length of the micro-bubble generator 336 is 1:4 or more. Accordingly, dissolved water contained in the tap water is subjected to a vortex caused by the frictional resistance between the inlets 332 and the friction inducing portions 337.

Here, the pressure resisting portion 335 causes pressure resistance to the tap water while the tap water flows along the inner wall 331 of the inlet 332 so that pressure resistance occurs between water flowing in the center of the inlet 332 and water flowing along the inner wall 331.

In this micro-bubble generator 336, water that has been introduced through the inlet 332 is subjected to frictional resistance caused by the friction inducing portion 337 while it flows along the inner wall 331 of the inlet 332, so that the water is refracted and the flow of the water is slowed down. Then, the pressure of the tap water that rapidly flows in one direction through the center of the inlet 332 and the frictional resistance that acts in the direction reverse to the direction in which the tap water flows cooperate to create a sudden vortex, which in turn causes expansion. A number of vortex layers are then formed in the water and this state is maintained until the water exits through the outlets 338, so that the expansion occurs several times in the water through the pressure resisting portion 335 and the friction inducing portion 337, thereby inducing the conversion of dissolved oxygen that is contained in the tap water into bubbles several times. Consequently, the dissolved water is converted into ultra-micro-bubbles having a size on the micrometer scale.

Accordingly, this maximizes the effects of sterilizing and purifying the tap water that contains the micro-bubbles compared to common tap water.

The bubble nozzle 340 is configured such that it scatters the micro-bubbles that are generated by the bubble nozzle 330 by applying impact or the like to the bubbles, so that the micro-bubbles generated by the bubble nozzle 330 undergo secondary conversion into ultra-micro-bubbles. Then, the bubble nozzle 340 discharges the resultant ultra-micro-bubbles into intended regions of the body.

Accordingly, the present invention performs the conversion of the tap water into micro-bubbles using the bubble nozzle 330 and the secondary conversion of the tap water into micro-bubbles using the discharge nozzle 340, so that dissolved oxygen contained in the tap water is further converted into ultra-micro-bubbles, thereby further maximizing the effects of purifying and sterilizing the tap water.

As shown in FIG. 6, the discharge nozzle 340 has threads 328 defined in the outer circumference thereof, the threads 328 corresponding to the coupling section 324 of the shower head 320. When the threads 328 are engaged with the coupling section 324, the threads 328 compress the watertight packing 350, which is disposed on the coupling section 324. The discharge nozzle 340 has a screw hole 342 formed in the central portion thereof, such that the discharge nozzle 340 and the bubble nozzle 330 are fixed to each other using a screw or the like. In addition, it is preferred that the discharge nozzle 340 be provided with a fastening cover 344, which surrounds the outer surface of the screw, in order to prevent the screw or the like from rusting.

Furthermore, the discharge nozzle 340 has discharge holes through which the tap water is discharged under a predetermined pressure. The discharge holes have the same diameters, and are divided into a plurality of first discharge holes 346 and a plurality of second discharge holes 348 which have different lengths. The first discharge holes 346 are shorter, and are formed in positions closer to the central axis of the discharge nozzle 340. The second discharge holes 348 are formed such that they are spaced apart at predetermined intervals from the central axis of the discharge nozzle 340, and are longer than the first discharge holes 346.

In the bubble nozzle 340 configured as above, an inner wall 345 extends inside the portion of the bubble nozzle 340 in which the first discharge holes 346 are formed. When the tap water containing the micro-bubbles that have been generated by the bubble nozzle 330 exits through the inner wall 345 of the discharge nozzle 340, the inner wall 345 causes backflows in the tap water, thereby generating secondary micro-bubbles, and the discharge holes cause frictional resistance. Accordingly, the tap water composed of the micro-bubbles is discharged.

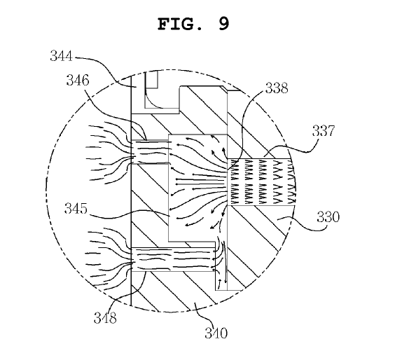

FIG. 7 to FIG. 9 are views showing the operation states of the micro-bubble shower according to an exemplary embodiment of the present invention.

As shown in the figures, in the micro-bubble shower 300 of the present invention, tap water is supplied through the water supply line 314 connected to the shower body 310, such that the tap water flows toward the shower head 320 through the passage 312 of the shower body 310. When the tap water flows into the shower head 320, the pressure of the tap water is increased by the inclined guide 326, which is formed in one end of the shower head, i.e. the lower portion of the receptacle 322, as shown in FIG. 7. The tap water is then introduced through the inlets 332 of the bubble nozzle 330, thereby executing first creation of micro-bubbles.

The micro-bubbles are first created by the bubble nozzle 330, as shown in FIG. 8. Specifically, the tap water that is introduced through the inlets 332 of the bubble nozzle 330, which is coupled to the shower head, is subjected to pressure resistance and frictional resistance, which are caused by a sudden change in the pressure between the lower end and the pressure resisting portion 335 of the inlets 332, so that expansion of dissolved oxygen that is contained in the tap water and vortexes in the tap water generate micro-bubbles from the dissolved oxygen that is contained in the tap water. The dissolved oxygen that has passed through the vortexes consecutively forms micro-bubbles until it exits through the outlets 338. This is caused by pressure resistance and frictional resistance that act between the tap water that flows straightly through the center of the inlets 332 and the bubble generator 336 and the tap water that flows along the inner wall 331, the pressure resisting portions 335 and the friction inducing portions 337 of the inlets 332

In addition, as shown in FIG. 9, the discharge nozzle 340 generates micro-bubbles again from the tap water that contains the micro-bubbles generated by the bubble nozzle 330. The tap water is then supplied through the multiple discharge holes including the first discharge holes 346 and the second discharge holes 348 to intended regions of the body of a user, so that the user can take a shower.

Here, the tap water that contains the first-generated micro-bubbles is introduced through the outlets 338 of the bubble nozzle 330 so as to collide against the inner wall 345 of the discharge nozzle 340, so that backflows occur in the tap water while the tap water remains under a predetermined pressure. The dissolved oxygen contained in the tap water then generates secondary micro-bubbles, i.e. ultra-micro-bubbles having a size on the micrometer scale, through expansion. Consequently, the resultant micro-bubbles are discharged through the first discharge holes 346 and the second discharge holes 348.

According to the present invention configured as above, the effects of purifying and sterilizing the tap water are maximized using the bubble nozzle 330, which generates micro-bubbles by expanding dissolved oxygen contained in the tap water into ultra-micro-bubbles having a size on the micrometer scale using a vortex caused by frictional resistance and pressure resistance due to variations in the pressure of the tap water. Accordingly, various kinds of skin diseases, such as itching, allergies, atopy and the like, caused by harmful bacilli contained in the tap water can be prevented. Furthermore, the bubble nozzle 330 can be used semi-permanently, and thus costs related to replacement and installation can be significantly reduced.

The foregoing descriptions of specific exemplary embodiments of the present invention have been presented for the purposes of illustration and description of the technical idea of the present invention. Many modifications and variations are possible to a person having ordinary skilled in the art without departing from the basic features of the present invention. The exemplary embodiments are intended to explain certain principles of the present invention, and the scope of the technical idea of the present invention is not limited by the foregoing embodiments. It is intended that the scope of protection of the present invention be defined by the Claims appended hereto, and it should be construed that all technical ideas equivalent to the Claims fall within the scope of protection of the present invention.

1. A micro-bubble generating shower comprising:
a shower head integrally provided in an upper portion of a shower body, which defines therein a passage through which tap water flows, wherein the shower head comprises a receptacle extending through the shower head and connected to the passage and a coupling section formed in a front end of the receptacle and having threads;
a bubble nozzle fixedly fitted into the receptacle of the shower head, wherein the bubble nozzle comprises a fastening hole extending through a central portion thereof, inlets connected to the passage such that the tap water is introduced into the inlets, pressure resisting portions for generating frictional resistance to dissolved oxygen contained in the tap water that is introduced into the inlets, friction inducing portions connected to the pressure resisting portions such that the frictional resistance occurs in the dissolved oxygen in the tap water, and outlets formed in lower ends of the friction inducing portions, such that the tap water exits through the outlets, wherein pressure resistance of the pressure resisting portions and the frictional resistance of the friction inducing portions convert the dissolved oxygen in the tap water into ultra-micro-bubbles in a micrometer scale so that micro-bubbles are created, so that effects of purifying and sterilizing the tap water are maximized; and
a discharge nozzle coupled to the coupling section of the shower head, with a watertight packing being compressed between the discharge nozzle and the coupling section, wherein the discharge nozzle comprises a screw hole fastened with the fastening hole of the bubble nozzle using a screw, such that the discharge nozzle is fixed to the bubble nozzle, a fastening cover surrounding an outer surface of the screw, and a plurality of discharge holes through which the tap water that contains the micro-bubbles generated by the bubble nozzle is discharged,
wherein the discharge holes of the discharge nozzle include a plurality of first discharge holes formed in a central portion of the discharge nozzle and a plurality of second discharge holes spaced apart at predetermined intervals from the first discharge nozzles, wherein an inner wall is formed inside a portion of the bubble nozzle in which the first discharge holes are formed, such that the inner wall causes the tap water that contains the micro-bubbles and exits from the bubble nozzle to flow backward, thereby generating secondary micro-bubbles.

2. The micro-bubble generating shower of claim 1, wherein the inlets have a diameter ranging from 0.7 mm to 1.2 mm.

3. The micro-bubble generating shower of claim 1, wherein the inlets comprise ten inlets formed in the bubble nozzle.
